(19) United States
(12) Patent Application Publication
(10) Pub. No.: US 2006/0191641 A1
(43) Pub. Date: Aug. 31, 2006

(54) Continuous manufacturing apparatus for fastener stringer

(76) Inventors: Kenichiro Iai, Toyama (JP); Koitsu Morioka, Toyama (JP)

Correspondence Address: Michael S. Leonard;Everest Intellectual Property Law Group, P.O. Box 708, Northbrook, IL, 60065, US

(21) Appl. No.: 11/345,917

(22) Filed: Feb. 2, 2006

(30) Foreign Application Priority Data
Feb. 25, 2005 (JP) 2005-051397

(51) Int. Cl. B32B 37/00

(52) U.S. Cl. 156/538; 156/552

(57) ABSTRACT

A continuous manufacturing apparatus for a fastener stringer, the apparatus comprising a tape guide capable of meeting sufficiently not only a conventional manufacturing speed but also acceleration of the manufacturing speed in recent years and generating no missing of an engaging element, wherein the tape guide includes a pair of nipping guide pieces which nip and guide a fastener tape, and urging means for elastically urging a core thread portion of an engaging element attaching edge portion of a fastener tape nipped by the nipping guide pieces toward a space between legs of an engaging element positioned and supported by a forming die, and wherein the core thread portion is pressed against a crotch of the engaging element securely with a predetermined pressing force by urging of the urging means and the engaging element is implanted firmly on the fastener tape under the state.

### BACKGROUND OF THE INVENTION

1. Field of the Invention

The present invention relates to a manufacturing apparatus for a fastener stringer for successively attaching an engaging element for a slide fastener, the engaging element obtained by cutting an engaging element linear material having a substantially Y-shaped section forged preliminarily in the direction of its lateral section and then molding a coupling head of the engaging element into a mountain-like shape, to a fastener tape guided by a tape guide and supplied intermittently. More particularly, the invention relates to a continuous manufacturing apparatus for a fastener stringer, the apparatus having a tape guide which enables engaging elements to be attached to a fastener tape securely by eliminating attachment impossibility or attachment failure due to flipping of the engaging elements accompanied by acceleration of the manufacturing process.

2. Description of the Related Art

As for this kind of the slide fastener engaging element, a long metallic linear material having a circular section is formed into a substantially Y shape in its lateral section through a plurality of mill rolls, fed intermittently only by an amount corresponding to a single engaging element, and successively cut out so as to have a predetermined thickness with a cutting punch and a cutting die, thereby engaging element materials are obtained. After that, by forming a coupling head into a mountain like shape with a forming punch and a forming die, an engaging element (hereinafter referred to as a linear material made engaging element) is formed. Usually, the cutting die is fixed to a part of a machine frame, and the cutting die and the forming die are integrated with a ram, and at the time of retraction, the cutting die cuts out a linear material together with the cutting punch. Thereafter, the forming punch is actuated to mold the linear material into a mountain like shape at its retraction stop end. Subsequently, the ram advances toward the engaging element attaching portion of the fastener tape and a pressurizing punch is actuated halfway of that process, so that right and left legs of the engaging element are implanted to the engaging element attaching portion of the fastener tape by pressurizing. After the engaging element is attached to the fastener tape, an intermittent feeding portion for intermittently feeding the fastener tape by an equal pitch is actuated so as to raise the fastener tape only by a pitch. Such a method for forming a linear material made engaging element has been disclosed in, for example, Japanese Patent Application Publication No. 59-51813.

The schematic configuration of the tape guide is shown in FIG. 5 of Japanese Patent Application Publication No. 59-51813. In a conventional tape guide, metallic nipping guide pieces obtained by machining are fixed to right and left side faces of a rectangular block which projects at right angle from a top end of a single square column guide main body. The pair of nipping guide pieces comprises flat plates fixed to the right and left side faces of the rectangular block, bent portions extending obliquely from the front ends thereof approaching each other, and nipping portions extending in parallel from the front ends of the bent portions. The bottom end of the square column guide main body is pivoted on a floor surface so as to swing back and forth, and the nipping portions at the top end are positioned at a constant position by urging means such as a spring such that the nipping portions are always urged toward a crotch between right and left legs of an engaging element formed into the mountain-like shape. The fastener tape is nipped and guided by a nipping force which allows it to slide by the pair of right and left nipping portions with its engaging element attaching edge left.

In the tape guide having the above-described configuration, the engaging element positioned and supported on the forming die moves following an advancement motion of the forming die together without any deviation of its position if a conventional manufacturing speed is provided. On the other hand, the engaging element attaching edge of the fastener tape nipped and guided by the tape guide is securely pressed against the crotch of the engaging element by an elasticity of a spring attached to the bottom end of the square column guide main body, so that right and left legs may be implanted on the fastener tape by pressurizing under that state.

However, the manufacturing speed has been accelerated remarkably in recent years. Even if the engaging element supported on the forming die moves following up a motion of the forming die, an elasticity of a spring attached to the bottom end of the square column guide main body of the tape guide does not allow a swing of the square column guide main body to follow up the back and forth motion of the forming die. Consequently, timing of pressing the engaging element attaching end of the fastener tape nipped by the tape guide against the engaging element deviates, thereby causing an event that the engaging element may be flipped away. Thus, missing of the engaging element that means no engaging element is implanted on a part of the fastener stringer occurs, thereby losing the quality of products and reducing the yield of products largely.

### SUMMARY OF THE INVENTION

The present invention has been achieved to solve such a problem, and an object of the invention is to provide a continuous manufacturing apparatus for a fastener stringer, capable of meeting sufficiently not only a conventional manufacturing speed but also acceleration of the manufacturing speed in recent years and generating no missing of an engaging element.

To achieve the above, according to the main aspect of the invention, there is provided a continuous manufacturing apparatus for a fastener stringer that successively attaches an engaging element for a slide fastener, the engaging element molded into a mountain-like shape between a forming punch and a forming die after a metallic linear material having a substantially Y-shaped section supplied intermittently is cut to the engaging element by a cutting punch in a direction perpendicular to a supplying direction of the metallic linear material, to a fastener tape supplied intermittently at a predetermined pitch by a guide of a tape guide, wherein the tape guide includes: a pair of nipping guide pieces for nipping and guiding the fastener tape; and urging means for elastically urging a core thread portion on an engaging element attaching edge portion of the fastener tape nipped by the nipping guide pieces toward a space between legs of the engaging element positioned and supported by the forming die.

According to a preferred aspect, the tape guide comprises the nipping guide piece, the urging means, a holding member for holding the nipping guide piece, and a guide main body fixed to a part of a frame, and the holding member is held slidably together with the nipping guide piece by the guide main body via the urging means. Preferably, the holding member is slidable with respect to the guide main body within a predetermined range, and has a contact face that makes a contact with the forming die in process of an advancement of the forming die toward the core thread portion.

The metallic linear material for molding the engaging element, the material having a desired section and supplied intermittently at a predetermined pitch, is subjected to multi-stage rolling process so as to have entirely a smooth substantially Y-shaped section, and is intermittently fed upward only by an amount corresponding to a single engaging element. When the feeding of the linear material is completed, the linear material is projected over the cutting die by a length corresponding to the thickness of a single engaging element. Next, the cutting die begins to go back, a projecting portion of the linear material is cut with a cutting punch and the engaging element is moved from the cutting die to the forming die at a rear end stopping place of the cutting die. At this time, a pressurizing hammer is stopped and the forming die controls supports mounting legs of the engaging element from both sides in order to restrict a horizontal movement of the engaging element.

Thereafter, the forming punch lowers and the pressure pad also lowers to mold the coupling head into a mountain-like shape. When the cutting die and forming die advance in cooperation, the pair of pressurizing punches are actuated, so that the mounting legs of the engaging element are pressed by pressurizing faces formed on the pressurizing punches and are deformed in a direction in which they approach each other. The engaging element is attached to the engaging element attaching portion of the fastener tape located in a standby position after supplied intermittently, and then, the intermittently feeding portion is actuated, so that a next engaging element attaching portion of the fastener tape is fed to the pressurizing portion of the pressurizing punches while being guided by the tape guide.

In recent years, manufacturing process has been accelerated remarkably not only in this kind of manufacturing apparatus for a fastener stringer but also in every manufacturing field. Thus, although an operating portion disposed separately from a main operating portion can follow up an operation timing of the main operating portion at a conventional manufacturing speed, it has become incapable of following up accelerated speed, thereby often leading to reduction of productivity. This is the same for the manufacturing apparatus for the fastener stringer, and particularly, an action of the tape guide which does not interlock directly with a ram but operates negatively using elasticity of a spring has got out of timing with a back and forth movement of the ram which is an especially accelerated main operating portion. As a consequence, the core thread portion of the fastener tape cannot be pressed against the crotch of the engaging element or the engaging element is often flipped away. For this reason, the engaging element cannot be attached firmly and accurately, or such an event that the engaging element is not attached to the fastener tape occurs.

According to the present invention, as described above, the nipping guide pieces of the tape guide have urging means for elastically urging the engaging element attaching edge of the fastener tape nipped by the nipping guide pieces toward a space between the legs of the engaging element supported by the forming die. Therefore, when the forming die is at its retracted position and the engaging element attaching edge is not yet in contact with the engaging element, the engaging element attaching edge is kept static at a position beyond the advancement end position of the forming die by an urging force of the urging means. Here, after the forming die begins to advance and the crotch of the engaging element makes contact with the engaging element attaching edge, the engaging element attaching edge is continuously pressed resisting the urging of the urging means. By setting the urging force at this time appropriately, the core thread portion of the engaging element attaching edge is, together with the nipping guide pieces of the tape guide, retracted with an advancement of the engaging element with deformed to a flat shape reasonably, and stops at the advancement end position of the forming die. Simultaneously at this time, the pressurizing punches pressurize the legs of the engaging element, thereby implanting the engaging element on the engaging element attaching edge of the fastener tape.

As described above, according to the invention, the engaging element on the forming die advances with the tape guide resisting the urging force of the tape guide up to the advancement end position of the forming die while being pressed against the engaging element attaching edge of the fastener tape nipped by the tape guide. In other words, the engaging element is moved and pressurized in a state in which the engaging element is elastically held by the forming guide and the engaging element attaching edge nipped by the tape guide during an advancement of the forming guide, and therefore, the engaging element on the forming die is implanted into the engaging element attaching edge in a state in which the engaging element is pressed against the engaging element attaching edge without any change in its supported position. Thus, the implantation of the engaging element is carried out securely regardless of the advancement/retraction speed of the forming die.

According to the preferred aspect of the tape guide, the tape guide has a holding member for holding the nipping guide pieces. The holding member is elastically urged toward the engaging element on the forming die between the guide main body and itself, so that the holding member is slidable relative to the guide main body within a predetermined range. The holding member has a contact face with the forming die, and the contact face makes contact with the forming die while the forming die advances toward the core thread portion of the engaging element attaching edge. At the time of this contact, a pressing force of the core thread portion of the engaging element attaching edge with respect to the crotch of the engaging element is fixed so as to inhibit a further urging force from being applied to the core thread portion, thereby protecting the core thread portion from further deformation.

### BRIEF DESCRIPTION OF THE DRAWINGS

FIG. 1 is a perspective view showing major portions of a continuous manufacturing apparatus for a fastener stringer, to which the invention is applied;

FIG. 2 is a longitudinal sectional view of an engaging element molding portion of the same apparatus;

FIG. 3 is an enlarged perspective view showing major portions of the engaging element molding portion comprising a tape guide to which a preferred embodiment of the invention is applied;

FIG. 4 is a sectional view showing an internal configuration of the same tape guide;

FIG. 5 is an explanatory view showing a positional relation between a forming die and a tape guide when the forming die is located at its advance start position; and

FIG. 6 is an explanatory view showing a positional relation between the forming die and the tape guide when the forming die is located at its advance stop end position.

### DESCRIPTION OF THE PREFERRED EMBDOIMENT

Hereinafter, a preferred embodiment of the invention will be described specifically with reference to the accompanying drawings.

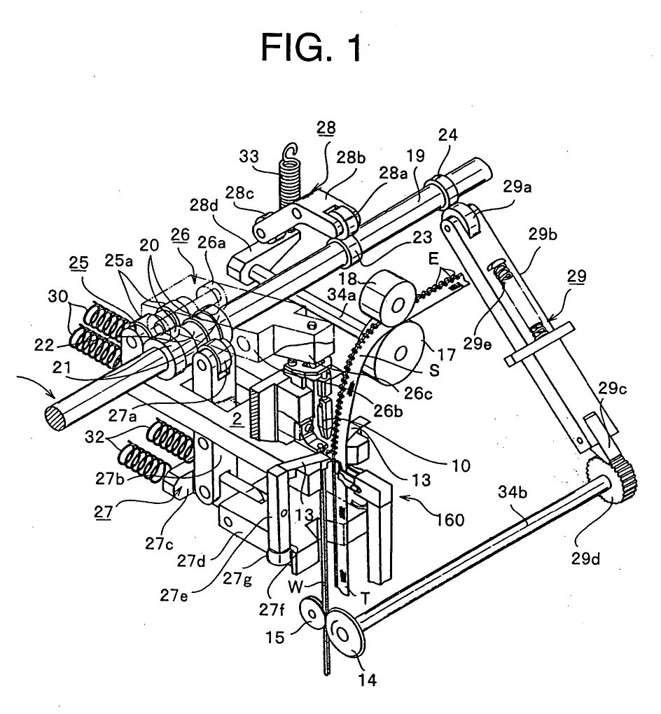

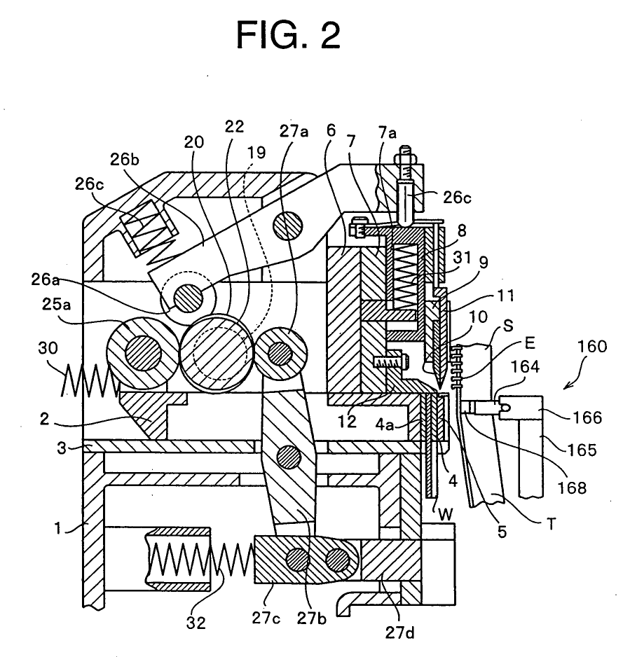

FIGS. 1 and 2 schematically show an example of major portions of a fastener stringer manufacturing apparatus of the invention. The structure of the indicated apparatus is substantially not different from the apparatus disclosed in the patent document 1. Thus, a following outline of the apparatus is based on the description of the above-mentioned publication. In these figures, a first ram 2 is supported on a base 1 through a ram guide 3 so as to be capable of reciprocating horizontally freely, and a cutting die 4 and a forming die 5 for molding a coupling head of an engaging element E into a mountain-like shape are provided on the front end of the first ram 2 in this order in an advancement direction of the first ram 2. The cutting die 4 has a through hole 4a through which a deformed linear material W for an engaging element passes, the linear material having, for example, a Y-shaped lateral section.

A set plate 6 supported by the base 1 is disposed above the front portion of the first ram 2, and a ram guide 7 is mounted on the set plate 6. A second ram 8 is provided on the ram guide 7 so as to be capable of moving up/down vertically with respect to the horizontal reciprocation of the first ram 2. A forming punch 10 for molding the coupling head of the engaging element E into a mountain like shape and a pressure pad 11 for pressing both legs of the engaging element E at the same time of molding into the mountain-like shape are mounted on the front face of the second ram 8 through a punch holder 9. Further, a cutting punch 12 capable of making sliding contact with the top face of the front portion of the first ram 2 is fixed on the bottom end of the ram guide 7. A pair of pressurizing punches 13 are provided on both sides above the forming die 5, so that mounting legs of the engaging element E after its coupling head is formed are pressurized from both sides of right and left, thereby attaching the engaging element E to the tape T.

As shown in FIG. 1, the linear material W for the engaging element having a Y-shaped section is supplied intermittently only by an amount corresponding to the thickness of a single engaging element E by feed rollers 14, 15 to the linear material through hole 4a in the cutting die 4. A fastener tape T is supplied from below and guided by a tape guide 160, and the fastener tape is turned to a slide fastener stringer S with the engaging elements E attached. The slide fastener stringer S is pulled intermittently by an intermittent drive roller 17 and a pressure roller 18 of an intermittent feeding portion.

A drive main shaft 19 is provided above the rear portion of the first ram 2, and on the main shaft 19, a first ram drive cam 20, a forming punch actuating cam 21, a pressurizing punch actuating cam 22, a stringer feeding cam 23 and a linear material feeding cam 24 are provided. The respective cams 20 to 24 are connected to the first ram 2, the forming punch 10, the pressurizing punches 13, the intermittent drive roller 17 and the linear material feed roller 14 via cam joint mechanisms 25 to 28 and these components are actuated.

The cam joint mechanism 25 of the first ram 2 has a first roller 25a which makes a rolling contact with the first ram drive cam 20, and the roller 25a is journaled by the rear portion of the first ram 2. The first ram 2 is urged in an advance direction by a compression spring 30, so that the first ram 2 is reciprocated horizontally by a rotation of the first ram drive cam 20. Further, the cam face of the first ram drive cam 20 is so formed that the first ram drive cam 20 stops in a predetermined time at its front end position and rear end position.

On the other hand, the cam joint mechanism 26 of the forming punch 10 comprises: a second roller 26a which makes a rolling contact with the forming punch actuating cam 21; a lever 26b, in which the roller 26a is journaled by one end of the lever, and which is mounted on the apparatus main body via a shaft at a central portion of the lever; a pin 26c which is attached to the other end of the lever 26b and makes contact with the head of the second ram 8; and a compression spring 26d which returns the lever 26b. The second ram 8 incorporates a compression spring 31 for urging the ram upward, and the lever 26b swings by the cam 21, so that the second ram 8 lowers and returns to its original position by the compression spring 31.

As shown in FIG. 1, the cam joint mechanism 27 of the pressurizing punch 13 comprises: a third roller 27a which makes a rolling contact with the cam 22; a lever 27b which journals the roller 27a at its top end, the lever extending downward and being supported on the base 1 via a shaft at a central portion thereof; a link 27c whose central portion is supported at the bottom end of the lever 27b via a shaft; a third ram 27d in which the front end of the link 27c is connected to a rear portion thereof; and an actuating lever 27e which the pressurizing punch 13 makes contact with at its top and whose central portion is connected via a shaft. The side face at the front end of the third ram 27d is formed as a cam face 27f extending outward, and a cam receiver 27g is provided at the bottom end of the actuating lever 27e. When the third ram 27d is retracted by the cam face 27f and the cam receiver 27g, the actuating lever 27e swings, thereby actuating the pressurizing punch 13. The third ram 27d is restored to its original position by the compression spring 32.

As shown in FIG. 1, the cam joint mechanism 28 for feeding a stringer comprises: a fourth roller 28a which makes a rolling contact with the stringer feeding cam 23; a first lever 28b in which the roller 28a is journaled by one end thereof and a fifth roller 28c is journaled by the other end and whose central portion is supported via a shaft; and a second lever 28d which swings downward by a sixth roller 28e and is urged upward by a pulling spring 33. A transmission shaft 34a of the intermittent drive roller 17, in which a single-direction clutch (not shown) is mounted on an intermediate portion of the transmission shaft, is connected to a proximal end of the second lever 28d, so that the intermittent drive roller 17 is rotated only in a single direction intermittently to feed the fastener stringer S.

The cam joint mechanism 29 for feeding a linear material comprises: a sixth roller 29a which makes a rolling contact with the cam 24; a slider 29b in which the roller 29a is supported at one end thereof; a ratchet 29c attached to the other end of the slider 29b; and a ratchet wheel 29d which is intermittently rotated only in a single direction by every predetermined angle by the ratchet 29c. The ratchet wheel 29d and the linear material feed roller 14 are connected with a transmission shaft 34b, and the linear material feed roller 14 supplies the linear material W intermittently. Restoration of the slider 29b to its original position is achieved by the compression spring 29e.

When the advancement of the first ram 2 stops, feeding of the deformed linear material W is completed, so that the deformed linear material W is projected over the cutting die 4 by a predetermined thickness. In a former half of this process, the attachment of the engaging element E to the fastener tape T is completed. The fastener stringer S is pulled up immediately after the pressuring punches 13, 13 leave the legs of the engaging element E, and when the coupling head of the engaging element E leaves the forming die 5, the first ram 2 begins to be retracted. Thus, the attached engaging element is never caught by the forming die 5 which is retracted and actuated by the first ram 2.

The linear material W is cut by the retraction of the first ram 2. At the time of this retraction, pulling up of the fastener stringer is completed. When the first ram 2 is located at its retraction position and the coupling head is formed, the pressurizing punches 13 are actuated to nip the engaging element E from both sides through its legs. After the attachment of the engaging element by the pressurizing punches 13 is started in process of the advancement of the first ram 2, the first ram 2 advances to the advance end position and hereinafter, the above-mentioned procedures are repeated.

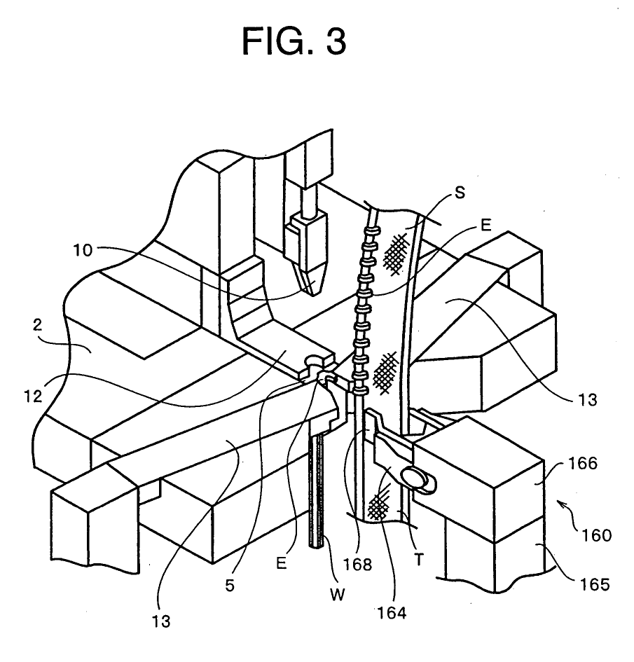

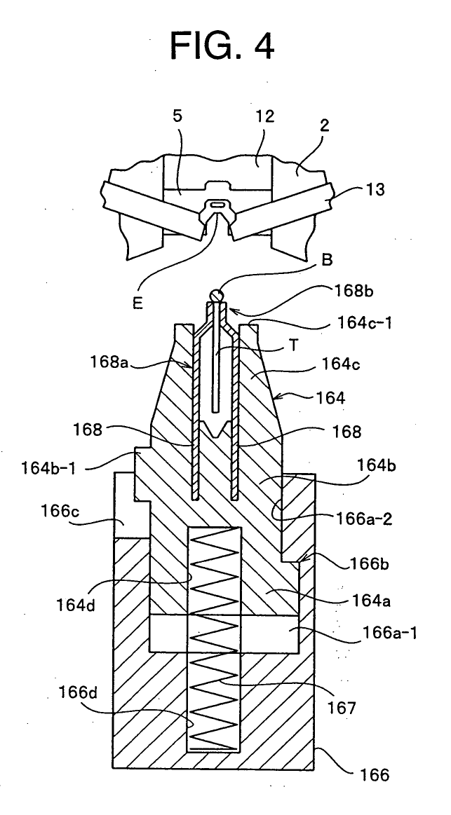

FIG. 3 shows an enlarged appearance of major portions around the tape guide 160 comprising a main configuration of the characteristic portion of the invention. As understood from the same figure, in the tape guide 160 of the embodiment, a rectangular block 166 is extended toward the forming die 5 perpendicularly to the top end of the square column guide main body 165 fixed on a part of a frame (not shown) and erected vertically. As shown in FIG. 4, a rectangular hollow portion 166a in which an extension end face is open in a substantially half portion in the extension direction is formed in the rectangular block 166. A first hollow portion 166a-1 which is a half portion opposite to the opening side of the rectangular hollow portion 166a is formed wider via a step 166b than a second hollow portion 166a-2 at the opening side. In addition, a cutout portion 166c is formed in a side portion opposite to the side portion in which the step 166b is formed. The cutout portion 166c has a combined shape of square and semicircle communicating with the opening-side second hollow portion 166a-2 and the opening. A first spring supporting hole 166d in which one end of a compression spring 167 is fitted and fixed is formed in the center of the bottom face of the hollow portion 166a.

A holding member 164 which is a main member of the present invention is incorporated in the hollow portion 166 having such a shape such that the holding member is slidable in a direction of the opening of the rectangular block 166. The holding member 164 comprises a first body portion 164a, a second body portion 164b provided continued from the first body portion 164a, and a pair of fork pieces 164c provided continued from the second body portion 164b. The first body portion 164a slides toward the opening within the first hollow portion 166a-1 of the hollow portion 166. The second body portion 164b has a sliding protrusion 164b-1 slidably fitted to the cutout portion 166c at one side face thereof, and slides toward the opening in the second hollow portion 166a-2. The pair of fork pieces 164c is narrow in thickness as it goes to its front end. A second spring supporting hole 164d in which the other end of the compression spring 167 is fitted and fixed is formed in the center of the end face of the first body portion 164a up to the second body portion 164b. A front end face 164c-1 of the fork piece 164c is formed in a flat plane perpendicular to the sliding direction of the holding member 164.

According to this embodiment, a pair of nipping guide pieces 168 for nipping the fastener tape T are disposed along opposing inner faces of the fork pieces 164c of the holding member 164, and the proximal ends of the nipping guide pieces are fixed in the second body portion 164b. The nipping guide pieces 168 are formed of spring steel and comprised of flat piece portions 168a extending from the proximal ends in the form of narrow strips and nipping portions 168b extending from the front end of the flat piece portions in a crank shape. The pair of flat piece portions 168a are disposed in parallel facing to each other and a gap formed between the nipping portions 168b bent in the crank shape narrows gradually, and the proximal ends are inserted into the second body portion 164b under this state and fixed in the holding member 164. In this case, the entire nipping portions 168b are projected out of the front end of the holding member 164. The gap formed at the front ends of the nipping portions 168b is set to a dimension sufficient for elastically nipping the front and rear faces of the fastener tape T and allowing the fastener tape T to slide in the tape length direction.

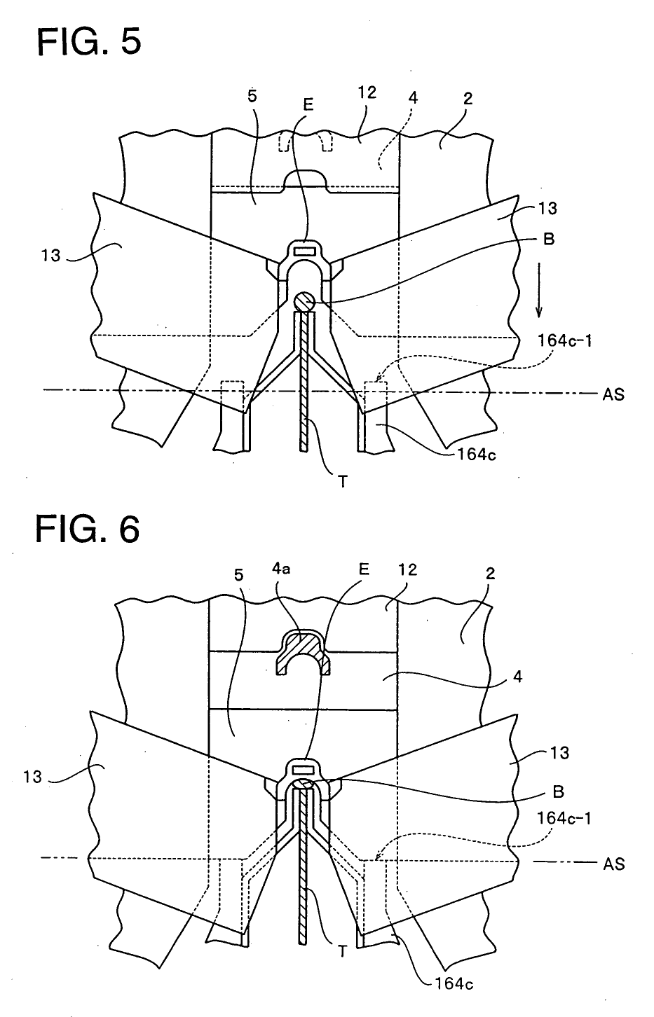

In the tape guide 160 comprising such a configuration, as shown in FIGS. 3 and 5, the bottom end of the square column guide main body 165 is fixed to the frame such that the front ends of the nipping portions 168b are directed to the crotch of the engaging element E positioned and placed on the top face of the forming guide 5. The fixing position of the bottom end of the guide main body 165 at this time is determined as follow. When the forming die 5 is located at a retraction stop position, the position of the core thread portion B of the fastener tape T nipped by the nipping portions 168b and projecting from their front ends and the position of the front end face 164c-1 of the fork piece 164c of the holding member 165 are fixed near the engaging element E beyond the advance stop end position AS of the forming die 5. For the invention, setting of the position of the core thread portion B, the position of the front end face 164c-1 of the fork piece 164c and the advance stop end position AS of the forming die 5 is very important.

In the fastener stringer manufacturing apparatus according to the embodiment equipped with the tape guide 160, the first ram 2 is retracted and an engaging element material is moved to a molding position on the top face of the forming die 5 by the front end of the immobile cutting punch 12. The engaging element material is obtained by cutting a projecting portion of the metallic wire W projecting upward from the linear material through hole 4a in the cutting die 4. Here, the forming punch 10 is actuated to create a coupling head by molding the engaging element into a mountain-like shape. After the molding into the mountain-like shape is finished, the first ram 2 begins to advance. In this advancement, the pressurizing punches begin to operate, so that the mounting legs of the engaging element E after the molding into the mountain-like shape are nipped from the right and left sides. The forming die 5 continues to advance toward the core thread portion B of the fastener tape T guided and supported by the tape guide 160. In process of the advancement, the crotch of the engaging element E placed on the forming die 5 makes contact with the vertex of the core thread portion B of the fastener tape T.

The advancement of the forming die 5 is continued further and the crotch of the engaging element E presses the core thread portion B with resisting an urge of the compression spring 167 and deforms the core thread portion to flat, thereby sliding the nipping guide pieces 168 together with the holding member 164 toward the bottom face of the hollow portion 166a-1 in the rectangular block 166. When the holding member 164 slides over a preliminarily set distance, the front end face of the forming die 5 comes into contact with the front end face 164c-1 of the fork piece 164c of the holding member 164.

At the time of this contact, the urging force of the core thread portion on the engaging element attaching edge with respect to the crotch of the engaging element E is fixed and no more urging force is applied to the core thread portion B, thereby preventing the core thread portion from being further deformed. Further, since the aforementioned contact is a facial contact between the forming die 5 which is a rigid body and the holding member 164, the holding member 164 is retracted with resisting the urging force of the hollow portion 166a-1, together with the advancement of the forming die 5, up to the advancement stop end position AS of the forming die 5 as shown in FIG. 6. As a consequence, the mounting legs of the engaging element E are pressurized accurately and securely at the implantation position on the fastener tape by the pressurizing punches 13, so that the engaging element E can be implanted firmly on the fastener tape T.

In the meantime, although not described in the above embodiment, the urging means for the tape guide of the invention is not limited to a case where the nipping guide pieces 168 are fixed to the holding member 164 while the holding member 164 and the nipping guide pieces 168 are urged with a single compression spring 167, it is permissible to interpose a second compression spring between the holding member 164 and the nipping guide pieces 168 also, so as to provide the holding member 164 and the nipping guide pieces 168 with respective urging forces by means of double urging means.

In this case, when the engaging element comes into contact with the core thread portion of the fastener tape, first, the nipping guide pieces 168 are retracted while compressing the second compression spring, and subsequently, the holding member 164 is retracted while compressing the first compression spring. Finally, the front face of the forming die 5 and the fork piece 164c of the holding member 164 are retracted while keeping a facial contact, so that the forming die 5 reaches the advancement stop end position AS. After the forming die 5 and the holding member 164 make facial contact with each other as well, a constant urging force of the nipping guide piece 168 acts against the crotch of the engaging element E, so that the engaging element E is held firmly between the forming die 5 and the nipping guide pieces 168.

What is claimed is:

1. A continuous manufacturing apparatus for a fastener stringer that successively attaches an engaging element for a slide fastener, the engaging element molded into a mountain-like shape between a forming punch and a forming die after a metallic linear material having a substantially Y-shaped section supplied intermittently is cut to the engaging element by a cutting punch in a direction perpendicular to a supplying direction of the metallic linear material, to a fastener tape supplied intermittently at a predetermined pitch by a guide of a tape guide, wherein
the tape guide includes:
a pair of nipping guide pieces for nipping and guiding the fastener tape; and
urging means for elastically urging a core thread portion of an engaging element attaching edge portion of the fastener tape nipped by the nipping guide pieces toward a space between legs of the engaging element positioned and supported by the forming die.

2. The continuous manufacturing apparatus according to claim 1, wherein the tape guide comprises the nipping guide pieces, the urging means, a holding member for holding the nipping guide pieces, and a guide main body fixed to a part of a frame, and the holding member is held slidably together with the nipping guide pieces by the guide main body via the urging means.

3. The continuous manufacturing apparatus according to claim 2, wherein the holding member is slidable with respect to the guide main body within a predetermined range, and has a contact face that makes a contact with the forming die in process of an advancement of the forming die toward the core thread portion.
